(19) United States
(12) Patent Application Publication
(10) Pub. No.: US 2026/0037431 A1
(43) Pub. Date: Feb. 5, 2026

(54) STORAGE DEVICE AND METHOD OF OPERATING THE SAME

(71) Applicant: SK hynix Inc., Icheon-si (KR)

(72) Inventors: Tae Ha KIM, Icheon-si (KR); Jung Ae KIM, Icheon-si (KR); Jung Woo KIM, Icheon-si (KR)

(21) Appl. No.: 19/055,989

(22) Filed: Feb. 18, 2025

(30) Foreign Application Priority Data
Aug. 1, 2024 (KR) 10-2024-0102630

(51) Int. Cl. G06F 12/02

(52) U.S. Cl. CPC G06F 12/0246; G06F 2212/7205

(57) ABSTRACT

A storage device includes a memory device and a controller. The memory device may include a plurality of zones which is a storage area respectively corresponding to logical address groups. The controller may control the memory device to exclude a source zone in which a data copy operation is performed according to a request of the host and select a victim zone satisfying a garbage collection trigger condition among the plurality of zones, and perform garbage collection for the victim zone.

### CROSS-REFERENCE TO RELATED APPLICATION

The present application claims priority under 35 U.S.C. § 119 (a) to Korean patent application number 10-2024-0102630 filed on Aug. 1, 2024, in the Korean Intellectual Property Office, the entire disclosure of which is incorporated by reference herein.

### BACKGROUND

### 1. Field of Invention

The present disclosure relates to an electronic device, and more particularly, to a storage device system and a method of operating the same.

### 2. Description of Related Art

A storage device is a device that stores data under control of a host device such as a computer or a smartphone. A storage device may include a memory device storing data and a controller controlling the memory device. Memory devices may be classified into volatile memory devices and nonvolatile memory devices.

Volatile memory devices are devices that store data only when power is supplied and lose stored data when the power supply is cut off. The volatile memory device may include a static random access memory (SRAM), a dynamic random access memory (DRAM), and the like.

Nonvolatile memory devices are devices that does not lose data even though power is cut off. The types of nonvolatile memory devices include a read only memory (ROM), a programmable ROM (PROM), an electrically programmable ROM (EPROM), an electrically erasable and programmable ROM (EEPROM), a flash memory, and the like.

### SUMMARY

An embodiment of the present disclosure provides a storage device that efficiently manages a storage space and a method of operating the same.

According to an embodiment of the disclosure, a storage device may include a memory device and a controller. The memory device may include a storage area organized into a plurality of zones respectively corresponding to a plurality of logical address groups. The controller may control the memory device to exclude a source zone in which a data copy operation is performed according to a request of the host and to select a victim zone, from among the plurality of zones, satisfying a garbage collection trigger condition and to perform garbage collection for the victim zone.

According to an embodiment of the disclosure, a method of operating a storage device may include excluding a source zone in which a data copy operation is performed according to a request of a host among the plurality of zones and selecting a victim zone satisfying a garbage collection trigger condition from among a plurality of zones, which is a storage area respectively corresponding to logical address groups, and performing garbage collection for the victim zone.

According to an embodiment of the disclosure, a storage device system may include a storage device and a host. The storage device may include a plurality of zones which is a storage area respectively corresponding to logical address groups. The host may provide a data copy command to the storage device instructing copying data stored in a first zone from among the plurality of zones to a second zone. The storage device may perform a data copy operation in response to the data copy command, exclude the first zone and select a victim zone satisfying a garbage collection trigger condition based on an execution history of the data copy operation from among the plurality of zones, and perform garbage collection for the victim zone.

According to the present technology, a storage device that efficiently manages a storage space and a method of operating the same are provided.

### BRIEF DESCRIPTION OF THE DRAWINGS

FIG. 1 is a drawing illustrating a storage device.

FIG. 2 is a drawing illustrating a memory device of FIG. 1.

FIG. 3 is a drawing illustrating a super block according to an embodiment of the disclosure.

FIG. 4 is a drawing illustrating an embodiment of managing a storage space of a storage device and a copy operation according to an embodiment of the disclosure.

FIG. 5 is a drawing illustrating an example in which host garbage collection and device garbage collection overlap.

FIG. 6 is a drawing illustrating a process of selecting a victim zone when performing device garbage collection according to an embodiment of the disclosure.

FIG. 7 is a flowchart illustrating an operation of a storage device according to an embodiment of the disclosure.

### DETAILED DESCRIPTION

Specific structural or functional descriptions of embodiments according to the concepts that are disclosed in the present specification or application are illustrated only to describe the embodiments according to the concepts of the present disclosure. The embodiments according to the concepts of the present disclosure may be carried out in various forms and are not limited to the embodiments described in the present specification or application.

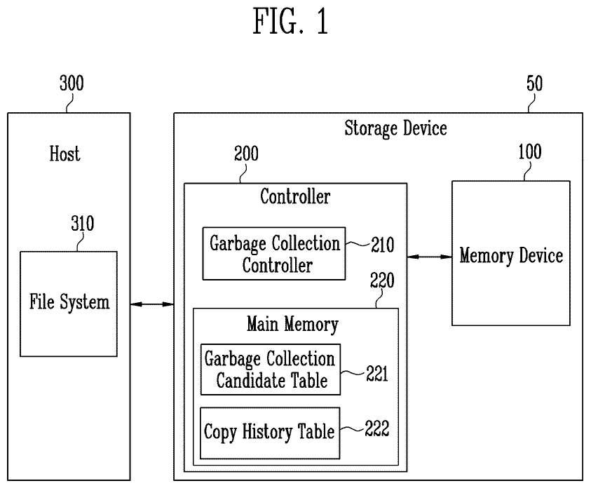

FIG. 1 is a drawing illustrating a storage device.

Referring to FIG. 1, a storage device system (not shown) may include a storage device 50 and a host 300 that controls the storage device 50.

The storage device 50 may include a memory device 100 and a controller 200. The storage device 50 may be a device that stores data under control of the host 300 such as a cellular phone, a smartphone, a laptop computer, a desktop computer, a game player, a smart TV, a tablet PC, or an in-vehicle infotainment system. In an embodiment, the storage device 50 may be a device that is controlled by the host 300 through wired or wireless communication to store data in a remote position, such as a server or a data center.

The storage device 50 may interface with the host 300 through various communication methods, and the storage device 50 may be configured as various devices according to an interfacing method. For example, the storage device 50 may be configured as one of various types of storage devices such as a solid state driver (SSD), an embedded multi-media card (eMMC), a secure digital card in a form of an SD, a mini-SD or a micro-SD, a universal serial bus (USB) storage device, a universal flash storage (UFS) device, a personal computer memory card international association (PCMCIA) card type storage device, a peripheral component interconnection (PCI) card type storage device, a PCI express (PCI-E) card type storage device, a compact flash (CF) card, and a smart media card.

In an embodiment, the storage device 50 may be manufactured as any one of various types of packages. For example, the storage device 50 may be manufactured as one of various types of package types, such as a package on package (POP), a system in package (SIP), a system on chip (SOC), a multi-chip package (MCP), a chip on board (COB), a wafer-level fabricated package (WFP), and a wafer-level stack package (WSP).

The memory device 100 may store data. The memory device 100 may operate in response to the control of the controller 200. The memory device 100 may include a plurality of memory cells storing data. Each of the memory cells may be configured to store one data bit or a plurality of data bits.

The memory cells may be accessed in a predetermined size unit according to a type of the memory device. A unit in which the memory cells are accessed may vary for each operation. For example, a write operation (program operation) of storing data in the memory cell, a read operation of sensing data stored in the memory cell, and an erase operation of erasing data stored in the memory cell may be accessed in different size units.

In an embodiment, the memory device 100 may be a double data rate synchronous dynamic random access memory (DDR SDRAM), a low power double data rate4 (LPDDR4) SDRAM, a graphics double data rate (GDDR) SDRAM, a low power DDR (LPDDR), a Rambus dynamic random access memory (RDRAM), a NAND flash memory, a vertical NAND flash memory, a NOR flash memory, a resistive random access memory (RRAM), a phase-change memory (PCM), a magnetoresistive random access memory (MRAM), a ferroelectric random access memory (FRAM), or a spin transfer torque random access memory (STT-RAM).

The memory device 100 may be configured to receive a command and an address from the controller 200 and access a region selected by an address in the memory cell array. The memory device 100 may perform an operation instructed by the command on the region selected by the address. For example, the memory device 100 may perform a write operation (program operation), a read operation, and an erase operation. During the program operation, the memory device 100 may record data in the region selected by the address. During the read operation, the memory device 100 may sense or read data from the region selected by the address. During the erase operation, the memory device 100 may erase data stored in the region selected by the address.

The controller 200 may control an overall operation of the storage device 50.

When power is applied to the storage device 50, the controller 200 may execute firmware (FW). The storage device 50 may convert a logical block address (LBA) provided by the host 300 into a physical block address (PBA) used by the memory device 100. The LBA may be an address for identifying data provided by the host. The PBA may be an address indicating a position where data is stored in the memory device 100. In the present specification, the LBA may have the same meaning as a logical address, and the PBA may have the same meaning as a physical address.

The controller 200 may control the memory device 100 to perform the write operation, the read operation, the erase operation, or the like according to a request of the host 300. During the write operation, the controller 200 may provide a write command (program command), an address, and data to the memory device 100. During the read operation, the controller 200 may provide a read command and an address to the memory device 100. During the erase operation, the controller 200 may provide an erase command and an address to the memory device 100.

The memory device 100 included in the storage device 50 may be managed as a plurality of zones. The plurality of zones may be areas managed and controlled by the host 300. The host 300 may control the storage device 50 so that data of the same type to be stored and a source of data generation are stored in the same zone.

For example, the host 300 may store data in the storage device 50 or request data stored in the storage device 50 according to the logical address. The logical addresses used by the host 300 may be logical addresses of a preset range. The host 300 may manage the logical addresses by dividing the logical addresses into a plurality of address groups, and may manage the logical addresses so that data corresponding to each address group is included in the same zone. That is, the plurality of zones may be managed to store data of corresponding address groups, respectively.

In an embodiment, the controller 200 may control the memory device 100 to perform various background operations so that data of the storage device 50 may be efficiently managed. For example, the controller 200 may control the memory device 100 to perform a garbage collection operation in order to increase the number of available free blocks for data storage from among memory blocks included in the memory device 100.

In an embodiment, the controller 200 may include an error correction code (ECC) circuit (not shown). Alternatively, the ECC circuit may be included in the storage device 50 as a chip or device separated from the controller 200. The ECC circuit (not shown) may detect and correct errors included in data obtained through the read operation from a memory die included in the memory device 100. In an embodiment, the number of bits that the ECC circuit may correct may be limited.

In an embodiment, the memory device 100 may include a plurality of zones, which organizes a storage area respectively corresponding to logical address groups provided from the host 300.

The controller 200 may select candidate zones satisfying a garbage collection trigger condition from among the plurality of zones. The controller 200 may exclude source zones in which a data copy operation is performed according to a request of the host 300 and may select victim zones from among the candidate zones. The controller 200 may control the memory device 100 to perform garbage collection for the victim zones.

In an embodiment, the controller 200 may include a garbage collection controller 210 and a main memory 220. The main memory 220 may store a garbage collection candidate table 221 and a copy history table 222.

The garbage collection controller 210 may identify the source zones based on at least one history information including the most recent history information from among history information included in the copy history table 222. The garbage collection controller 210 may identify the source zones based on the logical address and may select zones, while excluding the source zones, from among the candidate zones as the victim zones by referring to the garbage collection candidate table 221. The garbage collection controller 210 may control the memory device 100 to perform garbage collection by copying valid data stored in the victim zones to a target zone.

The garbage collection candidate table 221 may include a list of the candidate zones satisfying the garbage collection trigger condition. The garbage collection trigger condition may include a read reclaim condition, where a zone of which a read count is greater than or equal to a critical read count is selected as the candidate zone, a wear-leveling condition selecting a zone of which an erase and write count is greater than or equal to a critical erase and write count as the candidate zone, and a sudden power off recovery condition selecting the candidate zones based on whether data migration due to a sudden power off is performed.

The copy history table 222 may include history information on which data copy operations is performed according to the request of the host 300. Each history information may include a sequence number in which the data copy operation is performed, a source logical address and a length where copy data is stored, and a target logical address where the copy data is to be stored.

The host 300 may include a file system 310 for managing the storage space of the storage device 50. The file system 310 may access the plurality of zones based on information on logical addresses corresponding to the plurality of zones. The file system 310 may perform garbage collection of copying valid pages included in a zone, where data fragmentation is generated, to a new zone. The garbage collection may be referred to as host garbage collection since the garbage collection is performed under the control of the host 300.

The host garbage collection may be performed by the following methods. In a first method, the file system 310 may read data by providing a read command, for data stored at the logical address of the victim zone, to the storage device 50. The file system 310 may write data by providing a write command for the data to the logical address of the source zone. At this time, the file system 310 may provide a command including information on the victim zone to the storage device 50. In a second method, the file system 310 may perform garbage collection by providing a data copy command including the source logical address, the length of the logical address where data is stored, and the target logical address to the storage device 50. In an embodiment, the data copy command may be a small computer system interface (SCSI) copy command.

The storage device 50 may write data stored in the source logical address to the target logical address in response to the data copy command. The storage device 50 may identify a zone corresponding to the source logical address as the victim zone where the host garbage collection is performed using the history of the data copy command.

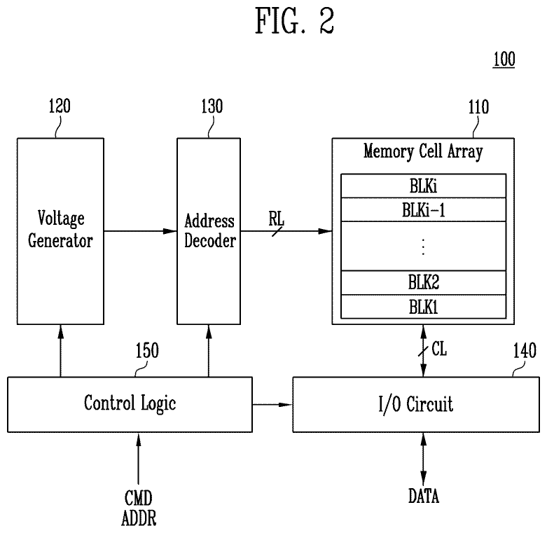

FIG. 2 is a diagram illustrating a memory device of FIG. 1.

Referring to FIG. 2, a memory device 100 may include a memory cell array 110, a voltage generator 120, an address decoder 130, an input/output circuit 140, and a control logic 150.

The memory cell array 110 may include a plurality of memory blocks BLK1 to BLKi. The plurality of memory blocks BLK1 to BLKi are connected to the address decoder 130 through row lines RL. The plurality of memory blocks BLK1 to BLKi may be connected to the input/output circuit 140 through column lines CL. In an embodiment, the row lines RL may include word lines, source select lines, and drain select lines. In an embodiment, the column lines CL may include bit lines.

Each of the plurality of memory blocks BLK1 to BLKi includes a plurality of memory cells. In an embodiment, the plurality of memory cells may be nonvolatile memory cells. Among the plurality of memory cells, memory cells connected to the same word line may be defined as one page. That is, each of the memory blocks BLK1 to BLKi may include a plurality of pages.

Each of the memory cells included in the memory cell array 110 may be configured as a single level cell (SLC) that stores one data bit, a multi-level cell (MLC) that stores two data bits, a triple level cell (TLC) that stores three data bits, or a quad level cell (QLC) capable of storing four data bits.

In an embodiment, the plurality of memory blocks BLK1 to BLKi may be allocated to the plurality of zones managed by the host 300 described with reference to FIG. 1, respectively. In an embodiment, a portion of the plurality of memory blocks BLK1 to BLKi may include a zone area allocated to the plurality of zones and a normal area that is not managed by the plurality of zones.

In an embodiment, the voltage generator 120, the address decoder 130, and the input/output circuit 140 may be collectively referred to as a peripheral circuit. The peripheral circuit may drive the memory cell array 110 under control of the control logic 150. The peripheral circuit may drive the memory cell array 110 to perform the write operation (program operation), the read operation, and the erase operation.

The voltage generator 120 is configured to generate a plurality of operation voltages using an external power voltage supplied to the memory device 100. The voltage generator 120 operates in response to the control of the control logic 150. In an embodiment, the voltage generator 120 may generate an internal power voltage by regulating the external power voltage. The internal power voltage generated by the voltage generator 120 may be used as an operation voltage of the memory device 100.

In an embodiment, the voltage generator 120 may generate the plurality of operation voltages using an external power voltage or an internal power voltage. The voltage generator 120 may be configured to generate various voltages required in the memory device 100. For example, the voltage generator 120 may generate a plurality of erase voltages, a plurality of program voltages, a plurality of pass voltages, a plurality of selected read voltages, and a plurality of unselected read voltages.

The voltage generator 120 may include a plurality of pumping capacitors that receive internal power voltage to generate the plurality of operation voltages having various voltage levels, and may generate a plurality of operation voltages by selectively activating the plurality of pumping capacitors in response to the control of the control logic 150.

The generated plurality of operation voltages may be supplied to the memory cell array 110 by the address decoder 130.

The address decoder 130 is connected to the memory cell array 110 through the row lines RL. The address decoder 130 may be configured to operate in response to the control of the control logic 150. The address decoder 130 may receive an address ADDR from the control logic 150. The address decoder 130 may decode a block address among the received addresses ADDR. The address decoder 130 may select at least one memory block among the memory blocks BLK1 to BLKi according to the decoded block address. The address decoder 130 may decode a row address among the received addresses ADDR. The address decoder 130 may select at least one word line among word lines of a selected memory block according to the decoded row address. In an embodiment, the address decoder 130 may decode a column address among the received addresses ADDR. The input/output circuit 140 and the memory cell array 110 may be connected to each other according to the decoded column address.

For example, the address decoder 130 may include components such as a row decoder, a column decoder, and an address buffer.

The input/output circuit 140 may include a plurality of page buffers (not shown). The plurality of page buffers may be connected to the memory cell array 110 through bit lines. During the write operation (program operation), data may be stored in selected memory cells according to data stored in the plurality of page buffers. During the read operation, the data stored in the selected memory cells may be sensed through the bit lines, and the sensed data may be stored in the page buffers.

The control logic 150 may control the address decoder 130, the voltage generator 120, and the input/output circuit 140.

The control logic 150 may operate in response to the command CMD transmitted from an external device. The control logic 150 may generate control signals in response to the command CMD and the address ADDR to control the peripheral circuits.

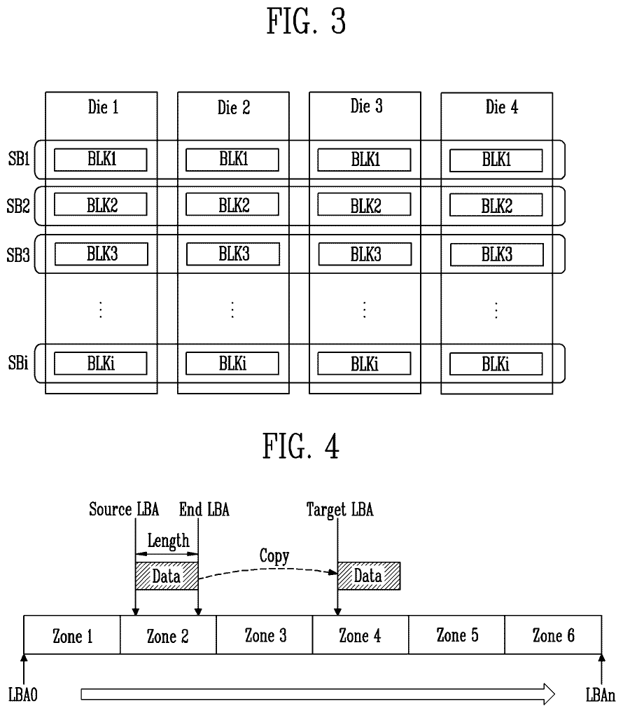

FIG. 3 is a drawing illustrating a super block according to an embodiment of the disclosure.

Referring to FIG. 3, each of a plurality of memory dies Die 1 to Die 4 may include a plurality of memory blocks BLK1 to BLKi. The memory blocks included in each memory die may configure a super block. The super block may be managed as a unit that configures one storage area.

For example, a first super block SB1 may include the first memory block BLK1 included in each memory die. A second super block SB2 may include the second memory block BLK2 included in each memory die. In a similar method, an i-th super block SBi may include the i-th memory block BLKi included in each memory die.

FIG. 4 is a diagram illustrating an embodiment of managing a storage space of a storage device and a copy operation according to an embodiment of the disclosure.

Referring to FIGS. 1 and 4, a host 300 may manage a storage space of a storage device 50 as a plurality of zones. A zone may be a storage area where sequential writing is performed. Therefore, write data corresponding to) successive logical addresses may be stored in a zone, and data may be managed with a block mapping method. The plurality of zones may be mapped one-to-one to a plurality of logical address groups in which the successive logical addresses are grouped.

For example, the host 300 may manage the storage space of the storage device 50 by dividing the storage space into first to sixth zones Zone 1 to Zone 6. The number of zones is not limited to the present embodiment. In FIG. 4, a logical address provided by the host 300 may be selected among a 0-th logical address LBA0 to an n-th logical address LBAn. Each of the 0-th logical address to n-th logical address LBA0 to LBAn may be divided into the plurality of logical address groups. For example, the 0-th logical address to the n-th logical address LBA0 to LBAn may be grouped into first to sixth logical address groups LBA Group 1 to LBA Group 6. The number of logical addresses included in each logical address group may be the same. The first to sixth zones Zone 1 to Zone 6 may be mapped to the first to sixth logical address groups LBA Group 1 to LBA Group 6, respectively.

Referring to FIGS. 3 and 4, a zone may correspond to at least one memory block. In an embodiment, a zone may correspond to a super block on a one-to-one basis. A size of a physical storage space corresponding to the zone is not limited to examples of the present embodiment.

The host 300 may provide a data copy command instructing copying data stored in a source zone, from among the plurality of zones, to the target zone in the storage device 50. The data copy command may include the source logical address and the length from where the copy data is stored and the target logical address where the copy data is to be stored.

In FIG. 4, the storage device 50 may copy data stored in the source logical address Source LBA of the second zone Zone 2, which is the source zone, to a logical address according to the data length and store the data in the target logical address Target LBA of the fourth zone, which is the target zone, in response to the data copy command.

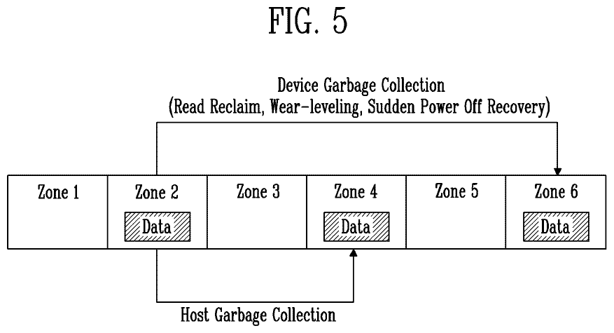

FIG. 5 is a diagram illustrating an example in which host garbage collection and device garbage collection overlap.

Referring to FIG. 5, garbage collection may be an operation of migrating valid data stored in a victim zone, from among a plurality of zones, to a target zone. The garbage collection may be divided into host garbage collection performed according to the request of a host and device garbage collection performed according to a trigger condition that exists in a storage device.

The host garbage collection may be an operation performed by the host of copying data, of a valid page included in a zone where data fragmentation is generated, to a new zone.

The device garbage collection may be an operation by the storage device of copying data, of a valid page included in the victim zone selected from among the candidate zones that satisfy the garbage collection trigger condition, to a new zone. The garbage collection trigger condition may include a read reclaim condition that selects the candidate zones based on a read count, a wear-leveling condition that selects the candidate zones based on an erase and write count, and a sudden power off recovery condition that selects the candidate zones based on whether data migration due to a sudden power off is performed.

In FIG. 5, a second zone Zone 2 may overlap as a victim zone of both of a device garbage collection and a host garbage collection. In this case, valid data stored in the second zone Zone 2 may be copied to the fourth zone Zone 4 in the host garbage collection and may be copied to the sixth zone Zone 6 in the device garbage collection. Thus, the valid data stored in the second zone Zone 2 may be duplicated and copied to the fourth zone Zone 4 and the sixth zone Zone 6, thereby reducing efficiency of the storage space of the storage device.

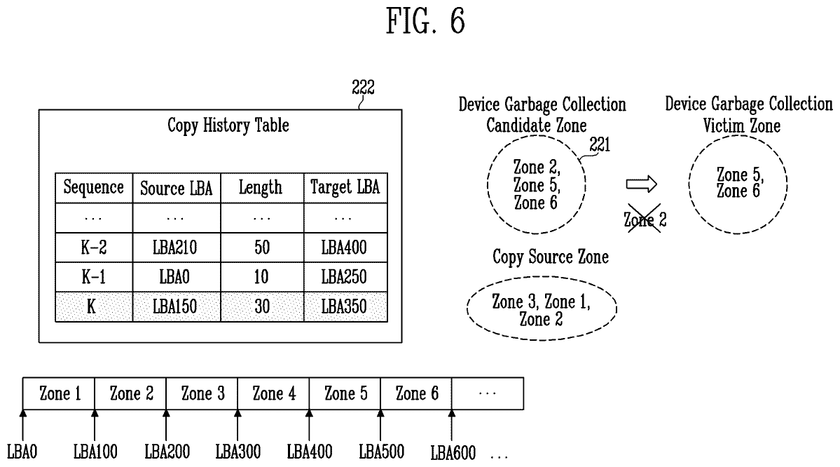

Therefore, an embodiment for preventing an overlap between the victim zone of the device garbage collection and the victim zone of the host garbage collection is described with reference to FIG. 6 below.

FIG. 6 is a diagram illustrating a process of selecting a victim zone when performing device garbage collection according to an embodiment of the disclosure.

Referring to FIG. 6, a garbage collection candidate table 221 may include a list of candidate zones satisfying a device garbage collection trigger condition described with reference to FIG. 5.

A copy history table 222 may include a history information about which data copy operation is performed. Each history may include a sequence number in which the data copy operation is performed, the source logical address where the copy data is stored, the data length, and the target logical address where the copy data is to be stored.

In FIG. 6, when referring to the garbage collection candidate table 221, the candidate zones satisfying the garbage collection trigger condition may be the second, fifth, and sixth zones Zone 2, Zone 5, and Zone 6.

In FIG. 6, in the execution history of K−2 to K-th data copy operations among the history information stored in the copy history table 222, a data copy operation of a (K−2)-th sequence number is an operation of copying valid data stored from the third zone Zone 3 to the fifth zone Zone 5 (LBA210 to LBA400). In addition, a data copy operation of a (K−1)-th sequence number is an operation of copying valid data stored in the first zone Zone 1 to the third zone Zone 3 (LBA0 to LBA250). Furthermore, a data copy operation of a K-th sequence number is an operation of copying valid data stored in the second zone Zone 2 to the fourth zone Zone 4 (LBA150 to LBA350).

When examining three histories including the most recent history from among the history information stored in the copy history table 222, the source zones of the data copy operation may be the first to third zones Zone 1 to Zone 3.

From among the second, fifth, and sixth zones Zone 2, Zone 5, and Zone 6, which are candidate zones of the device garbage collection, the storage device may select the fifth and sixth zones Zone 5 and Zone 6, while excluding the first to third zones Zone 1 to Zone 3 which are the source zones of the data copy operation, as the victim zones of the device garbage collection.

Through the embodiments described with reference to FIG. 6, the overlap of the victim zone of a host garbage collection and the victim zone of a device garbage collection may be prevented.

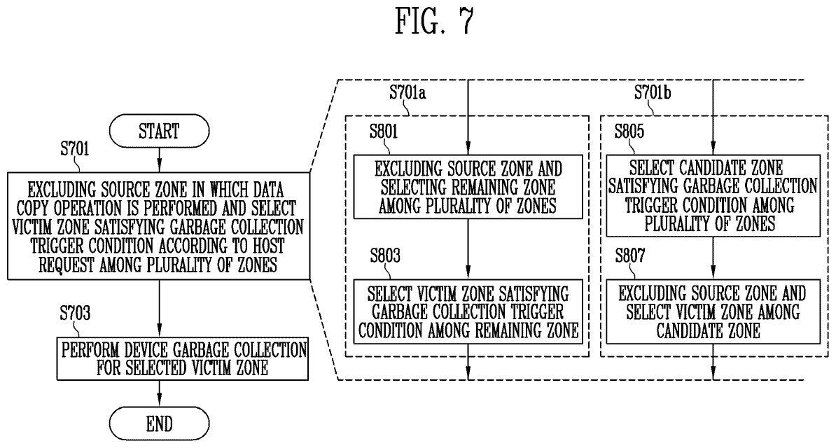

FIG. 7 is a flowchart illustrating an operation of a storage device according to an embodiment of the disclosure.

Referring to FIG. 7, in step S701, a storage device may exclude a source zone where a data copy operation according to a host request is performed, and may select a victim zone satisfying a garbage collection trigger condition from among a plurality of zones.

The garbage collection trigger condition may include a read reclaim condition that selects a victim zone based on a read count, a wear-leveling condition that selects a victim zone based on an erase and write count, and a sudden power off recovery condition that selects a victim zone based on whether data migration due to sudden power off is performed. The storage device may identify the source zone where the data copy operation is performed using a copy history table.

In an embodiment, step S701 may be executed as step S701a or step S701b.

Step S701a may include steps S801 and S803.

In step S801, the storage device may exclude a source zone and select a remaining zone from among a plurality of zones.

In step S803, the storage device may select a victim zone satisfying a garbage collection trigger condition from among the remaining zones.

Step S701b may include steps S805 and S807.

In step S805, the storage device may select a candidate zone satisfying the garbage collection trigger condition from among a plurality of zones.

In step S807, the storage device may exclude the source zone and select the victim zone from among the candidate zones.

In step S703, the storage device may perform device garbage collection for the selected victim zone.

What is claimed is:

1. A storage device comprising:
a memory device including a storage area organized into a plurality of zones respectively corresponding to a plurality of logical address groups; and
a controller configured to control the memory device to exclude a source zone in which a data copy operation is performed according to a request of a host and to select a victim zone, from among the plurality of zones, satisfying a garbage collection trigger condition and to perform garbage collection for the victim zone.

2. The storage device of claim 1, wherein the controller selects the victim zone, from among the plurality of zones, satisfying the garbage collection trigger condition after excluding the source zone.

3. The storage device of claim 1, wherein the controller selects a candidate zone from among a plurality of candidate zones satisfying the garbage collection trigger condition from among the plurality of zones, and then excludes the source zone and selects the victim zone from among the plurality of candidate zones.

4. The storage device of claim 3, wherein the controller comprises:
a garbage collection controller that controls the memory device to perform the garbage collection that copies valid data stored in the victim zone to a target zone from among the plurality of zones; and
a main memory that stores a garbage collection candidate table including a list of the plurality of candidate zones and a copy history table that includes a history information about which the data copy operation is performed.

5. The storage device of claim 4, wherein each of the history information includes a sequence number in which the data copy operation is performed, a source logical address and a data length where copy data is stored, and a target logical address where the copy data is to be stored.

6. The storage device of claim 5, wherein the garbage collection controller identifies the source zone based on the source logical address, excludes the source zone, and selects the victim zone from among the plurality of candidate zones.

7. The storage device of claim 4, wherein the garbage collection controller identifies the source zone based on at least one history information including the most recent history information.

8. The storage device of claim 1, wherein the garbage collection trigger condition includes at least one of a read reclaim condition that selects the victim zone based on a read count, a wear-leveling condition that selects the victim zone based on an erase and write count, or a sudden power off recovery condition that selects the victim zone based on whether data migration due to a sudden power off is performed.

9. The storage device of claim 1, wherein the controller performs the data copy operation in response to a small computer system interface (SCSI) copy command received from the host.

10. A method of operating a storage device, the method comprising:
excluding a source zone in which a data copy operation is performed according to a request of a host and selecting a victim zone satisfying a garbage collection trigger condition from among a plurality of zones, which is a storage area respectively corresponding to logical address groups; and
performing garbage collection for the victim zone.

11. The method of claim 10, wherein selecting the victim zone comprises:
selecting remaining zones excluding the source zone from among the plurality of zones; and
selecting the victim zone satisfying the garbage collection trigger condition from among the remaining zones.

12. The method of claim 10, wherein selecting the victim zone comprises:
selecting a candidate zone satisfying the garbage collection trigger condition from among the plurality of zones; and
excluding the source zone and selecting the victim zone from among a plurality of candidate zones.

13. The method of claim 10, wherein selecting the victim zone comprises:
determining whether the garbage collection trigger condition is satisfied based on a comparison result of a read count and a read reclaim count of each zone, a comparison result of an erase and write count and a wear leveling count, or whether data migration due to a sudden power off is performed.

14. The method of claim 10, wherein selecting the victim zone comprises:
identifying the source zone using history information about which the data copy operation is performed, and
each of the history information includes a sequence number in which the data copy operation is performed, a source logical address and a length where copy data is stored, and a target logical address where the copy data is to be stored.

15. The method of claim 14, wherein identifying the source zone comprises identifying the source zone based on source logical addresses included in at least one history information, including the most recent history information.

16. The method of claim 10, further comprising:
performing the data copy operation in response to a small computer system interface (SCSI) copy command received from the host.

17. A storage system comprising:
a storage device including a plurality of zones which is a storage area respectively corresponding to logical address groups; and
a host configured to provide a data copy command to the storage device instructing copying data stored in a first zone from among the plurality of zones to a second zone,
wherein the storage device performs a data copy operation in response to the data copy command, excludes the first zone and selects a victim zone satisfying a garbage collection trigger condition based on a history of the data copy operation from among the plurality of zones, and performs garbage collection for the victim zone.
